(19) United States
(12) Patent Application Publication
(10) Pub. No.: US 2016/0016591 A1
(43) Pub. Date: Jan. 21, 2016

(54) METHOD FOR CALCULATING REFERENCE MOTION STATE AMOUNT OF VEHICLE

(71) Applicant: Takahiro YOKOTA, (US)

(72) Inventor: Takahiro YOKOTA, Susono-shi (JP)

(73) Assignee: TOYOTA JIDOSHA KABUSHIKI KAISHA, Toyota-shi, Aichi (JP)

(21) Appl. No.: 14/772,586

(22) PCT Filed: Mar. 4, 2013
(86) PCT No.: PCT/JP2013/055867

§ 371 Date: Sep. 3, 2015

(51) Int. Cl. B60W 40/114

(52) U.S. Cl. CPC B60W 40/114; B60W 2040/1315

(57) ABSTRACT

Provided is a method of calculating a reference yaw rate as a reference motion state amount of a vehicle in a relationship of a first-order lag with respect to a normative yaw rate as a normative motion state amount of the vehicle. An overall weight (W) of the vehicle and a stability factor (Kh) of the vehicle are estimated (S20 and S30), cornering powers (Kf and Kr) of front and rear wheels and a yaw moment of inertia (Iz) of the vehicle are calculated based on the overall weight and the stability factor (S60 to S110). Then, a steering response time constant coefficient (Tp) for determining a time constant of the first-order lag is calculated based on the cornering powers (Kf and Kr) and the yaw moment of inertia (Iz) (S120), and the reference yaw rate is calculated by using the coefficient (S130).

### TECHNICAL FIELD

The present invention relates to control of a travel motion of a vehicle such as a motor vehicle, and more particularly, to a method of calculating a reference motion state amount used for the control of the travel motion.

### BACKGROUND ART

In the control of the travel motion of the vehicle, based on determination of whether or not a magnitude of a deviation between an actual yaw rate as an actual motion state amount of the vehicle and a reference yaw rate as a reference motion state amount of the vehicle exceeds a reference value, determination is made of whether or not a turn behavior of the vehicle is degraded. Then, when it is determined that the turn behavior is degraded, the travel motion of the vehicle is stabilized by controlling a braking force and a steering angle of each of wheels. In this case, the reference yaw rate is calculated as a value in a relationship of a first-order lag with respect to a normative yaw rate of the vehicle acquired based on a vehicle speed, a steering angle of front wheels, and a lateral acceleration of the vehicle.

A time constant of the first-order lag depends on the vehicle speed, and changes based on a load state of the vehicle. In particular, in the case of a vehicle such as a bus or a truck having a large variation of a movable load and a large variation of a center of gravity of the vehicle, a change in time constant of the first-order lag depending on the load state becomes larger compared to a passenger vehicle. Therefore, for example, as disclosed in Patent Literature 1, there has already been proposed a device for estimating a longitudinal position of the center of gravity of a vehicle and axle loads of the front and rear wheels, thereby estimating cornering powers of tires of the front and rear wheels that may cause a variation in the time constant of the first-order lag based on the estimation results.

If this estimation device is installed, the time constant of the first-order lag can be corrected based on the estimated cornering powers of the tires of the front and rear wheels. Thus, even for the vehicle having the larger variations in the movable load and in the center of gravity, the travel motion of the vehicle can appropriately be controlled during a turn compared to a case in which the time constant of the first-order lag is not corrected based on the cornering powers.

### CITATION LIST

### Patent Literature

[PTL 1] WO 2010/082288 A1

### SUMMARY OF INVENTION

### Technical Problem

However, the time constant of the first-order lag may also change depending on a change in yaw moment of inertia of the vehicle, and the yaw moment of inertia of the vehicle may also change depending on the load state of the vehicle. However, in the estimation device disclosed in Patent Literature 1, the change in time constant of the first-order lag caused by the change in yaw moment of inertia of the vehicle resulting from the change in load state of the vehicle is not considered, and there is room for improvement.

The present invention has been made in view of the above-mentioned problem in the calculation of the reference yaw rate as the reference motion state amount of the vehicle. Therefore, it is a primary object of the present invention to calculate the reference motion state amount of a vehicle used to control the travel motion of the vehicle highly precisely compared with related art by reflecting the change in time constant of the first-order lag caused by the change in yaw moment of inertia resulting from the change in load state of the vehicle.

### Solution to Problem and Advantageous Effects of Invention

According to one embodiment of the present invention, the above-mentioned primary problem can be solved by a method of calculating a reference motion state amount of a vehicle in a relationship of a first-order lag with respect to a normative motion state amount of the vehicle, the method including: estimating an overall weight of the vehicle and a stability factor of the vehicle; calculating an estimated value of a yaw moment of inertia of the vehicle based on the estimated overall weight and stability factor; calculating a time constant of the first-order lag by using the estimated value of the yaw moment of inertia; and calculating the reference motion state amount of the vehicle by using the calculated time constant.

In the above-mentioned configuration, the estimated value of the yaw moment of inertia of the vehicle is calculated based on the overall weight and the stability factor, the time constant of the first-order lag is calculated by using the estimated value of the yaw moment of inertia, and the reference motion state amount of the vehicle is calculated by using the time constant.

Thus, even when the overall weight of the vehicle and the vehicle longitudinal direction position of the vehicle center of gravity change, the yaw moment of inertia of the vehicle changed by those changes can be estimated. Then, even when the yaw moment of inertia of the vehicle changes depending on the change in load state of the vehicle, the reference motion state amount of the vehicle can highly precisely be calculated by using the time constant of the first-order lag reflecting the change.

Further, according to one embodiment of the present invention, in the above-mentioned configuration, the time constant of the first-order lag is a product of a vehicle speed and a coefficient, and the coefficient is calculated by using the estimated value of the yaw moment of inertia.

In the above-mentioned configuration, the coefficient is calculated by using the estimated value of the yaw moment of inertia. Therefore, even when the overall weight of the vehicle and the vehicle longitudinal direction position of the vehicle center of gravity change, the time constant of the first-order lag can be precisely calculated based on the changes. Thus, independently of the changes in the overall weight of the vehicle and the vehicle longitudinal direction position of the vehicle center of gravity, the reference motion state amount of the vehicle in the relationship of the first-order lag with respect to the normative motion state amount of the vehicle can correctly be calculated.

Further, according to one embodiment of the present invention, in the above-mentioned configuration, cornering powers of a front wheel and a real wheel may be calculated based on the overall weight of the vehicle and the vehicle longitudinal direction position of the center of gravity of the vehicle, and the coefficient may be calculated by using the estimated value of the yaw moment of inertia and the cornering powers of the front wheel and the rear wheel.

In the above-mentioned configuration, the cornering powers of the front wheel and the rear wheel are calculated based on the overall weight of the vehicle and the vehicle longitudinal direction position of the vehicle center of gravity, and the coefficient is calculated by using the estimated value of the yaw moment of inertia and the cornering powers of the front wheel and the rear wheel.

Thus, compared with the case in which the coefficient is calculated by using the estimated value of the yaw moment of inertia and the cornering powers of the front wheel and the rear wheel set in advance, even in a case in which the overall weight of the vehicle and the vehicle longitudinal direction position of the vehicle center of gravity change, the coefficient can correctly be calculated. Thus, independently of the changes in the overall weight of the vehicle and the vehicle longitudinal direction position of the vehicle center of gravity, the reference motion state amount of the vehicle can more precisely be calculated.

Further, according to one embodiment of the present invention, in the above-mentioned configuration, a change amount of the overall weight of the vehicle and a change amount of the vehicle longitudinal direction position of the vehicle center of gravity with respect to a standard state of the vehicle may be estimated based on the estimated overall weight and stability factor; a change amount of the yaw moment of inertia of the vehicle may be estimated based on the change amount of the overall weight of the vehicle and the change amount of the vehicle longitudinal direction position of the vehicle center of gravity; and a sum of the estimated change amount of the yaw moment of inertia and a standard value of the yaw moment of inertia set in advance for the standard state of the vehicle may be calculated as the estimated value of the yaw moment of inertia of the vehicle.

In the above-mentioned configuration, the change amount of the overall weight of the vehicle and the change amount of the vehicle longitudinal direction position of the vehicle center of gravity with respect to the standard state of the vehicle are estimated, and the change amount of the yaw moment of inertia of the vehicle is estimated based on those change amounts. Then, the sum of the estimated change amount of the yaw moment of inertia and the standard value of the yaw moment of inertia set in advance for the standard state of the vehicle is calculated as the estimated value of the yaw moment of inertia of the vehicle.

Thus, even when the overall weight of the vehicle and the vehicle longitudinal direction position of the vehicle center of gravity change as a result of a change in load state of the vehicle, the change amount of the yaw moment of inertia of the vehicle caused by those changes can be estimated, and as a result, the yaw moment of inertia of the vehicle can be correctly estimated. Thus, even when the yaw moment of inertia of the vehicle changes depending on the change in load state of the vehicle, the time constant of the first-order lag can be changed so as to reflect the change thereof, and as a result, the reference motion state amount of the vehicle can highly precisely be calculated.

Further, according to one embodiment of the present invention, in the above-mentioned configuration, a storage device for storing a relationship acquired in advance between the overall weight of the vehicle and the stability factor of the vehicle, and the yaw moment of inertia of the vehicle, and storing a relationship acquired in advance between the overall weight of the vehicle and the stability factor of the vehicle, and the cornering powers of the front wheel and the rear wheel may be used to calculate the estimated value of the yaw moment of inertia of the vehicle and the estimated value of the cornering powers of the front wheel and the rear wheel; and the estimated value of the yaw moment of inertia and the estimated values of the cornering powers of the front wheel and the rear wheel may be used to calculate the time constant of the first-order lag.

In the above-mentioned configuration, the storage device for storing the relationship is used to calculate the estimated value of the yaw moment of inertia of the vehicle and the estimated values of the cornering powers of the front wheel and the rear wheel, and the time constant of the first-order lag is calculated by using those estimated values. Thus, compared with a case in which the change amount of the overall weight of the vehicle and the change amount of the vehicle longitudinal direction position of the vehicle center of gravity with respect to the standard state of the vehicle are estimated, and the yaw moment of inertia of the vehicle is estimated based thereon, the yaw moment of inertia of the vehicle can easily be calculated. Moreover, compared with the case in which the axle loads of the front wheel and the rear wheel are estimated based on the overall weight of the vehicle and the vehicle longitudinal direction position of the vehicle center of gravity, and the cornering powers of the front wheel and the rear wheel are calculated based thereon, the estimated values of the cornering powers of the front wheel and the rear wheel can easily be calculated. Thus, the time constant of the first-order lag can easily be calculated, and as a result, the reference motion state amount of the vehicle can easily be calculated.

Further, according to one embodiment of the present invention, in the above-mentioned configuration, the time constant of the first-order lag is a product of a vehicle speed and a coefficient, and the coefficient may be calculated by using the estimated value of the yaw moment of inertia and the estimated values of the cornering powers of the front wheel and the rear wheel.

In the above-mentioned configuration, the coefficient can easily be calculated, and as a result, the time constant of the first-order lag can easily be calculated.

Further, according to one embodiment of the present invention, in the above-mentioned configuration, when one of the overall weight of the vehicle and the stability factor of the vehicle is equal to or less than a threshold based on the other thereof, the yaw moment of inertia may be set to the standard value without calculating the estimated value of the yaw moment of inertia of the vehicle.

When the change amount of the overall weight of the vehicle and the change amount of the stability factor of the vehicle are small, the change amount of the yaw moment of inertia of the vehicle from the standard value is also small. Thus, necessity of calculating the estimated value of the yaw moment of inertia of the vehicle is low, and the estimated value may not need to be calculated.

In the above-mentioned configuration, when one of the overall weight of the vehicle and the stability factor of the vehicle is equal to or less than the threshold based on the other thereof, the estimated value of the yaw moment of inertia is set to the standard value without calculating the estimated value of the yaw moment of inertia of the vehicle. Thus, in a state in which the amount of change in yaw moment of inertia of the vehicle from the standard value is small, the calculation of the estimated value of the yaw moment of inertia of the vehicle can be omitted, and a calculation load on a device for calculating the reference motion state amount of the vehicle can be reduced.

A wheelbase of a vehicle is represented by L, an actual steering angle of front wheels is represented by δ, and a lateral acceleration of the vehicle is represented by Gy. Moreover, a vehicle speed is represented by V, a stability factor of the vehicle is represented by Kh, and the Laplacian is represented by s. A reference yaw rate of the vehicle yst is represented by Expression (1). In other words, the reference yaw rate of the vehicle yst is calculated as a value of a first-order lag with respect to a normative yaw rate γt, which is a value in parentheses on the right side of Expression (1).

$$γ st = \frac{1}{1 + T pVs} ( \frac{δ V}{L} - khGyV ) \qquad ( 1 )$$

Tp in Expression (1) is a coefficient multiplied to the vehicle speed V of the time constant of the first-order lag, and a product of the vehicle speed V and the coefficient Tp is the time constant of the first-order lag. If the yaw moment of inertia of the vehicle is represented by Iz, and the cornering powers of the front wheel and the rear wheel are respectively represented by Kf and Kr, the coefficient Tp is represented by Expression (2). As used herein, the coefficient is referred to as “steering response time constant coefficient”.

$$Tp = \frac{Iz}{{L}^{2}} ( \frac{1}{Kf} + \frac{1}{Kr} ) \qquad ( 2 )$$

Therefore, in one preferred aspect of the present invention, the reference motion state amount is the reference yaw rate of the vehicle in the relationship of the first-order lag with the normative yaw rate of the vehicle, and the steering response time constant coefficient Tp may be calculated in accordance with Expression (2) based on the yaw moment of inertia Iz of the vehicle and the cornering powers Kf and Kr of the front wheel and the rear wheel.

In another preferred aspect of the present invention, the change amount of the yaw moment of inertia of the vehicle may be estimated as the yaw moment of inertia of only the movable load.

In another preferred aspect of the present invention, when one of the overall weight of the vehicle and the stability factor of the vehicle is equal to or less than a threshold determined by the other thereof, the time constant of the first-order lag may be set to the time constant for the standard state of the vehicle without calculating the estimated value of the yaw moment of inertia of the vehicle and the estimated values of the cornering powers of the front wheel and the rear wheel.

In another preferred aspect of the present invention, each time the time constant of the first-order lag is updated, the overall weight of the vehicle, the stability factor of the vehicle, and the time constant of the first-order lag are stored in the non-volatile storage device. The difference between the estimated overall weight of the vehicle and the overall weight of the vehicle stored in the storage device and the difference between the estimated stability factor of the vehicle and the stability factor of the vehicle stored in the storage device are respectively set to the change amount of the overall weight of the vehicle and the change amount of the stability factor of the vehicle. When one of the change amount of the overall weight of the vehicle and the change amount of the stability factor of the vehicle is equal to or less than the threshold determined by the other change amount thereof, the time constant of the first-order lag may be set to the value stored in the storage device without calculating the estimated value of the yaw moment of inertia of the vehicle and the estimated values of the cornering powers of the front wheel and the rear wheel.

### BRIEF DESCRIPTION OF DRAWINGS

FIG. 1 is a diagram for illustrating a vehicle whose travel motion is controlled by using a reference motion state amount calculation method according to a first embodiment of the present invention.

FIG. 2 is a side view for illustrating specifications such as a wheelbase of the vehicle.

FIG. 3 is a flowchart for illustrating a routine of calculating a reference yaw rate yst according to the first embodiment.

FIG. 4 is a flowchart for illustrating a routine of controlling travel motion of the vehicle carried out by using the reference yaw rate yst.

FIG. 5 is a map for determining whether or not calculation of a steering response time constant coefficient Tp is unnecessary based on an overall weight W of the vehicle and a stability factor Kh of the vehicle.

FIG. 6 is another map for determining whether or not the calculation of the steering response time constant coefficient Tp is unnecessary based on the overall weight W of the vehicle and the stability factor Kh of the vehicle.

FIG. 7 is a flowchart for illustrating the routine of calculating the reference yaw rate yst according to a second embodiment of the present invention.

FIG. 8 is a flowchart for illustrating a principal part of the routine of calculating the reference yaw rate according to a first modified example corresponding to the first embodiment.

FIG. 9 is a flowchart for illustrating a principal part of the routine of calculating the reference yaw rate according to a second modified example corresponding to the second embodiment.

FIG. 10 is a map for determining whether or not the calculation of the steering response time constant coefficient Tp is unnecessary based on a change amount ΔW of the overall weight of the vehicle and a change amount ΔKh of the stability factor of the vehicle.

FIG. 11 is another map for determining whether or not the calculation of the steering response time constant coefficient Tp is unnecessary based on the change amount ΔW of the overall weight of the vehicle and the change amount ΔKh of the stability factor of the vehicle.

FIG. 12 is a map for calculating a cornering power Kf of a tire of a front wheel based on the overall weight W of the vehicle and the stability factor Kh of the vehicle.

FIG. 13 is a map for calculating a cornering power Kr of a tire of a rear wheel based on the overall weight W of the vehicle and the stability factor Kh of the vehicle.

FIG. 14 is a map for calculating a yaw moment of inertia Iz of the vehicle based on the overall weight W of the vehicle and the stability factor Kh of the vehicle.

FIG. 15 is a map for calculating a movable load Wlo of the vehicle, which is a change amount of the weight of the vehicle with respect to a standard weight Wv, based on the overall weight W of the vehicle and the stability factor Kh of the vehicle.

FIG. 16 is a map for calculating a distance Lf in a vehicle longitudinal direction between a center of gravity of the vehicle and an axle of the front wheel based on the overall weight W of the vehicle and the stability factor Kh of the vehicle.

FIG. 17 is a map for calculating an axle load Wf of the front wheel based on the overall weight W of the vehicle and the stability factor Kh of the vehicle.

FIG. 18 is a map for calculating an axle load Wr of the rear wheel based on the overall weight W of the vehicle and the stability factor Kh of the vehicle.

### DESCRIPTION OF EMBODIMENTS

A detailed description is now given of some preferred embodiments of the present invention referring to accompanying drawings.

### First Embodiment

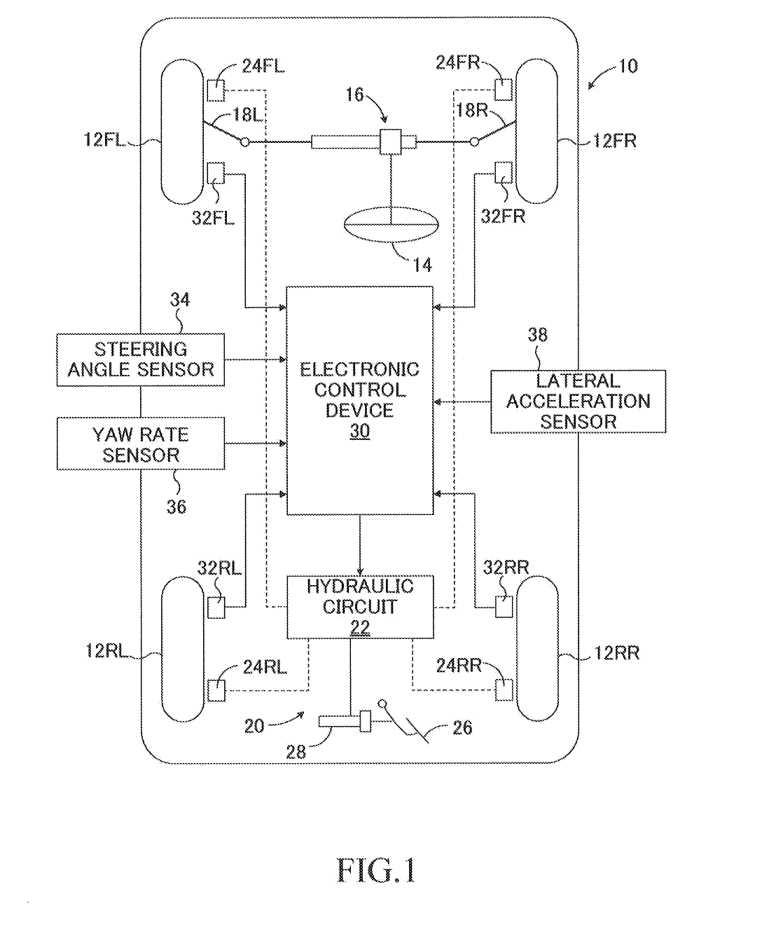

FIG. 1 is a diagram for illustrating a vehicle whose travel motion is controlled by using a reference motion state amount calculation method according to a first embodiment of the present invention.

In FIG. 1, an overall vehicle is represented by reference numeral 10, and the vehicle 10 includes front left and right wheels 12FL and 12FR and rear left and right wheels 12RL and 12RR. The front left and right wheels 12FL and 12FR, which are steered wheels, are steered via tie rods 18L and 18R by a power steering device 16 of the rack-and-pinion type driven in response to an operation by a driver on a steering wheel 14. It should be noted that, in the illustrated embodiment, the vehicle 10 is a minivan, but may be any vehicle such as a bus or a truck having large variation ranges of a magnitude and a position of a movable load.

Braking forces of the respective wheels are controlled by controlling braking pressures of wheel cylinders 24FR, 24FL, 24RR, and 24RL by a hydraulic circuit 22 of a braking device 20. The hydraulic circuit 22 includes an oil reservoir, an oil pump, and various valve devices, which is not shown. The braking pressure in the each wheel cylinder is controlled by a master cylinder 28 driven in response to a depressing operation on a brake pedal 26 by the driver in a normal state, and is also controlled by an electronic control device 30 depending on necessity as described later.

Wheel speed sensors 32FR to 32RL for detecting wheel speeds Vwi (i=fr, fl, rr, and rl) of the corresponding wheels are arranged on the wheels 12FR to 12RL, and a steering angle sensor 34 for detecting a steering angle θ is arranged on a steering column coupled to the steering wheel 14. It should be noted that FR, FL, RR, and RL, and fr, fl, rr, and rl respectively represent the front right wheel, the front left wheel, the rear right wheel, and the rear left wheel.

Moreover, a yaw rate sensor 36 for detecting an actual yaw rate γ of the vehicle, and a lateral acceleration sensor 40 for detecting a lateral acceleration Gy of the vehicle are arranged on the vehicle 10. It should be noted that the steering angle sensor 34, the yaw rate sensor 36, and the lateral acceleration sensor 40 respectively detect the steering angle, the actual yaw rate, and the lateral acceleration with a left turn direction of the vehicle being positive.

As illustrated, signals representing the wheel speeds Vwi detected by the wheel speed sensors 32FR to 32RL, a signal representing the steering angle θ detected by the steering angle sensor 34, and a signal representing the actual yaw rate γ detected by the yaw rate sensor 36 are input to the electronic control device 30. Similarly, a signal representing the lateral acceleration Gy detected by the lateral acceleration sensor 40 is also input to the electronic control device 30.

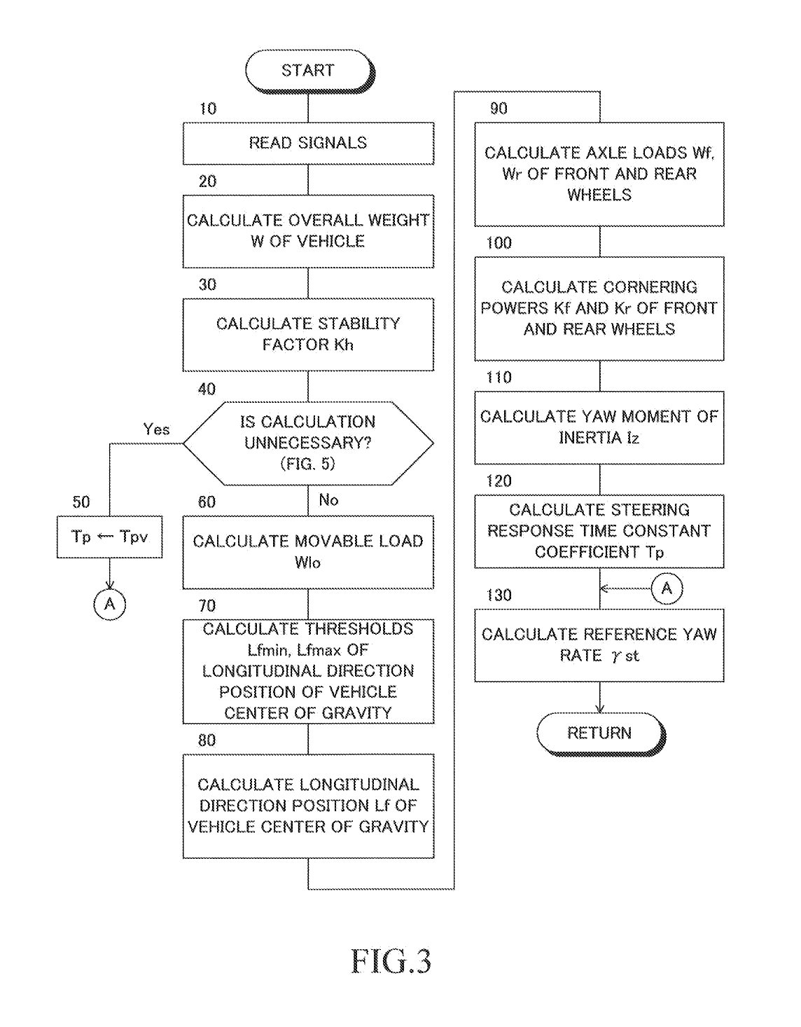

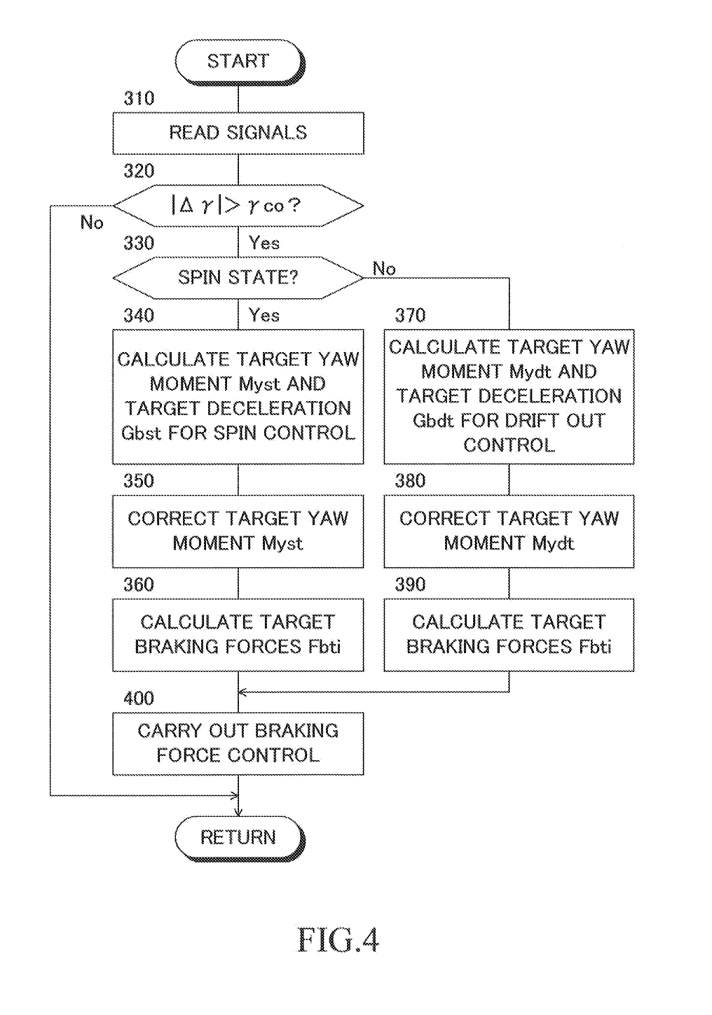

The electronic control device 30 includes a microcomputer having a typical configuration that includes, for example, a CPU, a ROM, an EEPROM, a RAM, a buffer memory, and an input/output port device, and in which those components are connected to one another via a bidirectional common bus, which is not illustrated in detail. The ROM stores flowcharts illustrated in FIG. 3 and FIG. 4, and various values for a standard state of the vehicle described later.

The electronic control device 30 follows the flowchart illustrated in FIG. 3 as described later to calculate the overall weight W of the vehicle and the like, and calculates, based on the calculated result, the yaw moment of inertia Iz of the vehicle and the cornering powers Kf and Kr of the tires of the front and rear wheels. Moreover, the electronic control device 30 calculates the steering response time constant coefficient Tp based on the yaw moment of inertia Iz and the cornering powers Kf and Kr, and uses the steering response time constant coefficient Tp to calculate the reference yaw rate yst of the vehicle. Then, the electronic control device 30 follows the flowchart illustrated in FIG. 4 as described later to determine whether or not a turn behavior of the vehicle is degraded, and the turn motion of the vehicle thus needs to be stabilized based on a deviation Δγ between the actual yaw rate γ of the vehicle and the reference yaw rate yst. Further, when the electronic control device 30 determines that the turn motion needs to be stabilized, the electronic control device 30 controls the braking forces of the respective wheels so as to stabilize the turn motion of the vehicle.

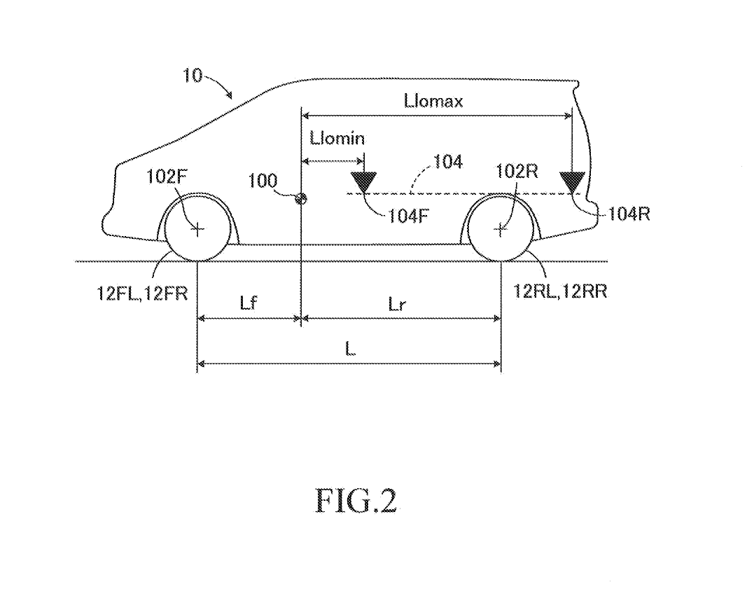

FIG. 2 is a side view for illustrating specifications such as a wheelbase of the vehicle. As illustrated in FIG. 2, the center of gravity 100 of the vehicle 10 is in an area of the wheelbase L of the vehicle 10. In other words, the center of gravity 100 exists between an axle 102F of the front wheels 12FL and 12FR and an axle 102R of the rear wheels 12RL and 12RR. Reference numerals Lf and Lr respectively denote a distance in the vehicle longitudinal direction between the center of gravity 100 and the axle 102F of the front wheels, and a distance between the center of gravity 100 and the axle 102R of the rear wheels. Moreover, reference symbols Llomin and Llomax respectively denote a distance in the vehicle longitudinal direction between the center of gravity 100 and a front end 104F of a cargo bed 104 and a distance in the vehicle longitudinal direction between the center of gravity 100 and a rear end 104R of the cargo bed 104, and those values are known.

Now, referring to a flowchart illustrated in FIG. 3, a description is given of a routine of calculating the reference yaw rate yst of the first embodiment. It should be noted that the control in accordance with the flowchart illustrated in FIG. 3 is started by closing of an ignition switch, which is not shown in the diagram, and is repeated at a predetermined period. This holds true for the travel motion control of the vehicle in accordance with the flowchart illustrated in FIG. 4 described later.

First, in Step 10, the signal representing the steering angle θ detected by the steering angle sensor 34 and the like are read.

In Step 20, based on a braking/driving force of the vehicle and an acceleration/deceleration of the vehicle, the overall weight W[kg] of the vehicle is calculated as an estimated value. In this case, for example, a procedure disclosed in Japanese Patent Application Laid-open No. 2002-33365 filed by the present applicant may be employed. In other words, the overall weight of the vehicle may be calculated in consideration of a travel resistance of the vehicle based on the driving force of the vehicle and the acceleration of the vehicle.

In Step 30, based on a state amount during a turn of the vehicle, a stability factor Kh of the vehicle is calculated as an estimated value. In this case, for example, a procedure disclosed in Japanese Patent Application Laid-open No. 2004-26073 filed by the present applicant may be employed. In other words, the estimated value of the stability factor Kh of the vehicle may be calculated by estimating a parameter of a transfer function from the normative yaw rate of the vehicle to the actual yaw rate.

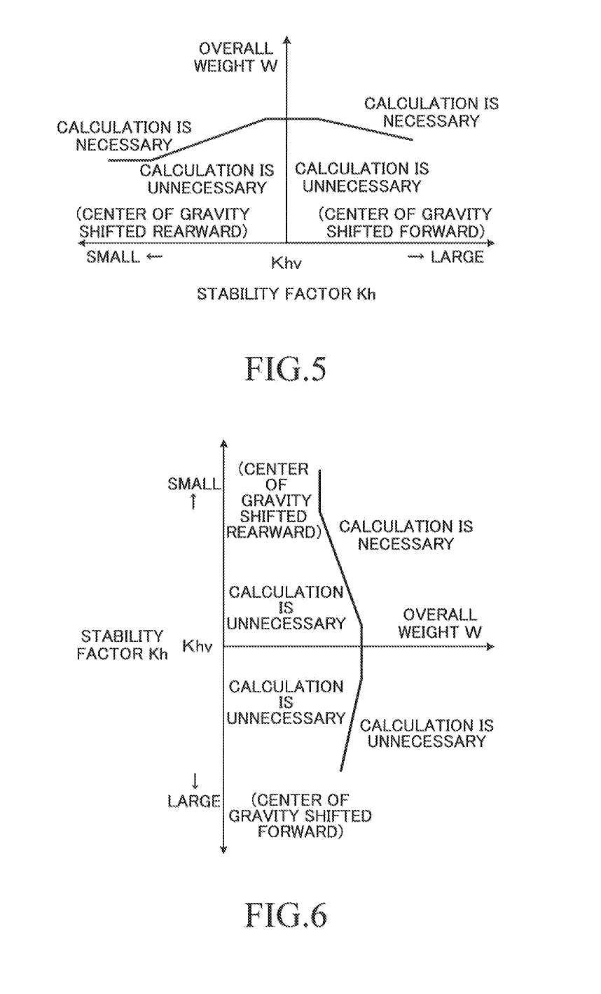

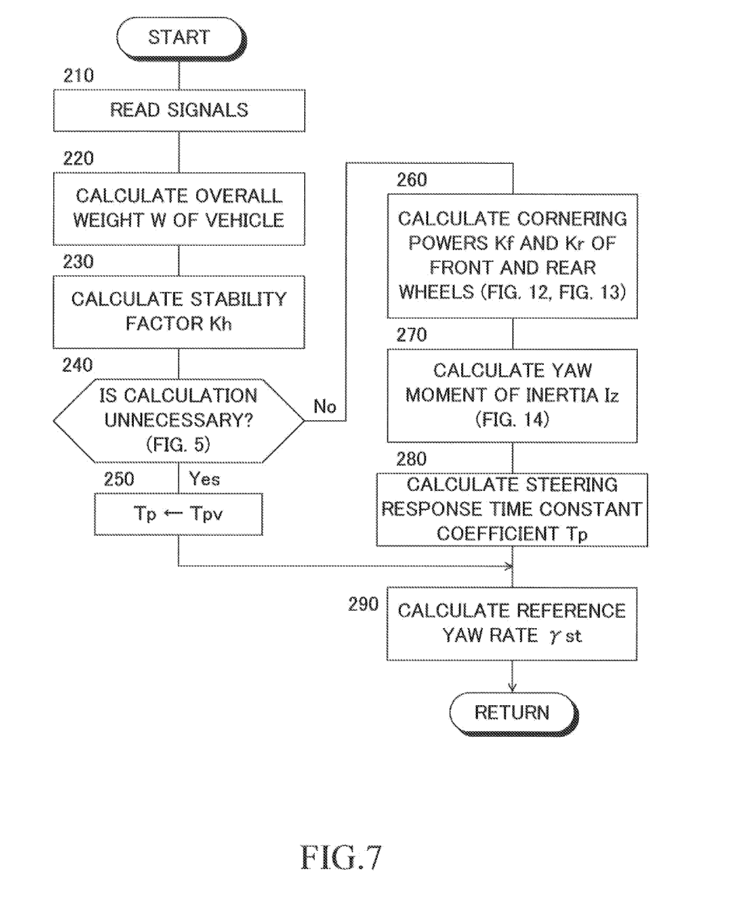

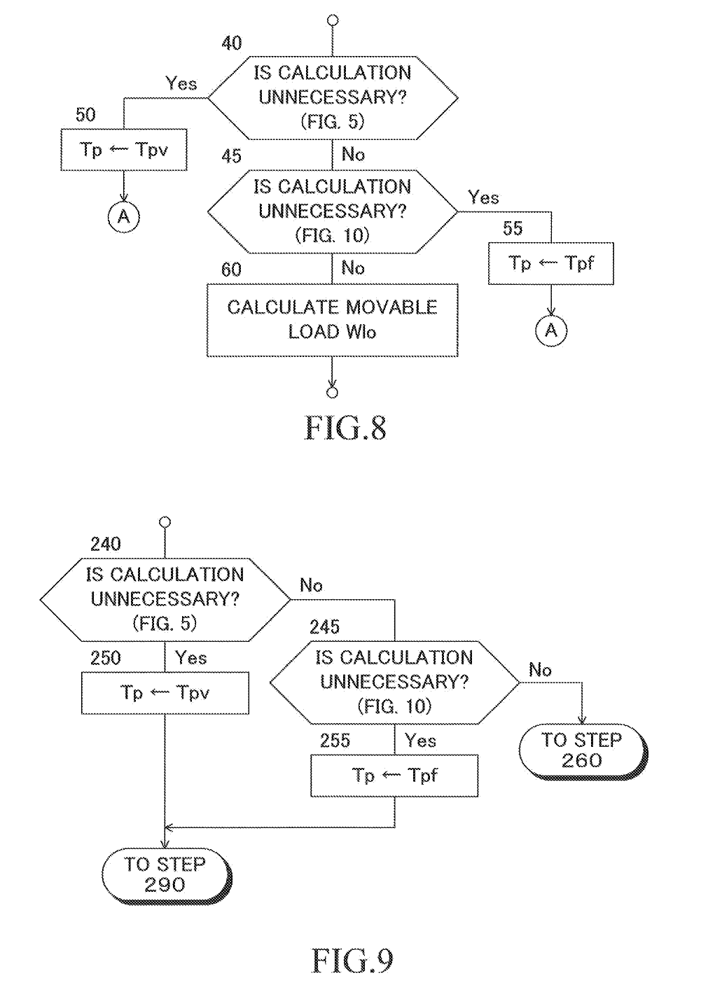

In Step 40, whether or not the calculation of the steering response time constant coefficient Tp is unnecessary is determined using a map illustrated in FIG. 5 based on the estimated overall weight W and stability factor Kh of the vehicle. Then, when a negative determination is made, the control proceeds to Step 60, and when an affirmative determination is made, the control proceeds to Step 50.

It should be noted that, in Step 40, as illustrated in FIG. 5, whether or not the overall weight W of the vehicle is equal to or less than a threshold determined by the stability factor Kh of the vehicle is determined. However, as illustrated in FIG. 6, whether or not the stability factor Kh of the vehicle is equal to or less than a threshold determined by the overall weight W of the vehicle may be determined.

In Step 50, the steering response time constant coefficient Tp is set to a standard value Tpv set in advance for the standard state of the vehicle without calculating the yaw moment of inertia Iz of the vehicle and the like, and then, the control proceeds to Step 130.

In Step 60, the standard weight of the vehicle is set to Wv[kg], and a movable load Wlo[kg] of the vehicle, which is a change amount of the weight of the vehicle with respect to the standard weight Wv is calculated in accordance with Expression (3). It should be noted that the standard weight Wv may be a weight of the vehicle in a standard state of the vehicle without the movable load, for example, in a state in which two persons are seated on a driver seat and a passenger seat.

Wlo=W−Wv (3)

In Step 70, based on the standard weight Wv and the movable load Wlo of the vehicle, the minimum threshold Lfmin[m] and the maximum threshold Lfmax[m] of the vehicle longitudinal direction position of the center of gravity 100 of the vehicle are calculated in accordance with Expressions (4) and (5), respectively. It should be noted that the minimum threshold Lfmin[m] and the maximum threshold Lfmax[m] of the vehicle longitudinal direction position of the center of gravity may be calculated by using a map, which is not shown, based on the overall weight W and the movable load Wlo of the vehicle.

$$\begin{matrix}Lf min = \frac{WvLfv + Wli Llo min}{Wv + Wlo} & ( 4 ) \\ Lf max = \frac{WvLfv + Wli Llo max}{Wv + Wlo} & ( 5 )\end{matrix}$$

In Step 80, based on the overall weight W and the stability factor Kh of the vehicle, a distance Lf[m] in the vehicle longitudinal direction between the center of gravity 100 of the vehicle and the axle 102F of the front wheels is calculated. The calculation of the distance Lf in this case may be carried out in a way disclosed, for example, in WO2010/082288 filed by the present applicant. Moreover, when the calculated value of the distance Lf is smaller than the minimum threshold Lfmin, the calculated value is corrected to the minimum threshold Lfmin, and when the calculated value of the distance Lf is larger than the maximum threshold Lfmax, the calculated value is corrected to the maximum threshold Lfmax, thereby applying guard processing of preventing the calculated value from exceeding a range between the thresholds.

In Step 90, a distance Lr (=L−Lf) [m] between the center of gravity 100 of the vehicle and the axle 102R of the rear wheels is calculated. Moreover, based on the overall weight W of the vehicle and the distances Lr and Lf between the center of gravity of the vehicle and the axles, an axle load Wf[kg] of the front wheels and an axle load Wr [kg] of the rear wheels are calculated respectively in accordance with Expressions (6) and (7).

Wf=WLr/L (6)

Wr=WLf/L (7)

In Step 100, based on the axle load Wf of the front wheels and the axle load Wr of the rear wheels, the cornering powers Kf and Kr of the tires of the front wheel and the rear wheel in a two-wheel model of the vehicle is calculated. The calculation of the cornering powers Kf and Kr in this case may be carried out in a way disclosed, for example, in WO2010/082288 filed by the present applicant.

In Step 110, the yaw moment of inertia Iz[kgm²] of the vehicle is calculated based on the overall weight W of the vehicle, the movable load Wlo (weight of the movable load) of the vehicle, the distance Lf, the standard weight of the vehicle Wv, and a distance Lfv between the center of gravity of the vehicle and the axle of the front wheel in the standard state of the vehicle.

For example, the axle load of the rear wheel in the standard state of the vehicle is denoted by Wry (known value), and first, a change amount ΔWr (=Wr−Wrv) of the axle load Wr of the rear wheel caused by the movable load is calculated. Then, based on the weight Wlo of the movable load and the change amount ΔWr of the axle load Wr of the rear wheel, a distance Lflo[m] in the vehicle longitudinal direction between the center of gravity 108 of the movable load 106 and the axle 102F of the front wheel is calculated in accordance with Expression (8). It should be noted that guard processing is applied to the distance Lflo so as not to exceed the above-mentioned range between the minimum threshold Lfmin and the maximum threshold Lfmax.

Lflo=LLWr/Wlo (8)

Moreover, it is assumed that the center of gravity of the vehicle is at the center of gravity when a movable load exists, and a yaw moment of inertia Izv[kg m²] of the vehicle and a yaw moment of inertia Izlo[kgm²] of the movable load in the standard state are respectively calculated in accordance with Expressions (9) and (10). It should be noted that Izv0 is the yaw moment of inertia Iz of the vehicle in the standard state of the vehicle. Moreover, Plo is a weight proportional term, namely, a coefficient multiplied to the movable load in order to acquire the yaw moment of inertia only for the movable load.

Izv=Izv0+Wv(Lf−Lfv)² (9)

IzIo=WloPlo+Wlo(Lf−Lflo)² (10)

Further, the yaw moment of inertia Iz[kgm²] of the vehicle is calculated in accordance with Expression (11) based on the yaw moments of inertia Izv and Izlo of the vehicle and the movable load.

Iz=Izv+Izlo (11)

In Step 120, based on the cornering powers Kf and Kr of the tires of the front wheel and the rear wheel, and also based on the yaw moment of inertia Iz of the vehicle, the steering response time constant coefficient Tp is calculated in accordance with Expression (2).

In Step 130, an actual steering angle δ of the front wheel is calculated based on the steering angle θ, and the vehicle speed V is calculated based on the wheel speeds Vwi. Then, based on the actual steering angle δ of the front wheel, the lateral acceleration Gy of the vehicle, and the vehicle speed V, by using the steering response time constant coefficient Tp calculated in Step 50 or 120, in accordance with Expression (1), the reference yaw rate yst of the vehicle is calculated.

Referring to the flowchart illustrated in FIG. 4, a description is now given of travel motion control of the vehicle carried out by using the reference yaw rate yst.

First, in Step 310, a signal representing the actual yaw rate γ of the vehicle detected by the yaw rate sensor 36 for detecting the actual yaw rate γ of the vehicle and the signal representing the reference yaw rate yst of the vehicle calculated as described above are read.

In Step 320, the deviation Δγ between the actual yaw rate γ of the vehicle and the reference yaw rate yst is calculated, and whether or not the turn behavior of the vehicle is degraded is determined by determining whether or not an absolute value of the yaw rate deviation Δγ exceeds a reference value γco (positive value). Then, when a negative determination is made, the control is tentatively finished, and when an affirmative determination is made, the control proceeds to Step 430.

In Step 330, based on a relationship between the sign of the actual yaw rate γ and the sign of the yaw rate deviation Δγ, whether or not the vehicle is in a spin state (oversteer state) is determined. Then, when a negative determination is made, the control proceeds to Step 370, and when an affirmative determination is made, the control proceeds to Step 340.

In Step 340, a slip angle of the vehicle and the like are calculated, and a spin state amount SS representing a degree of the spin state of the vehicle is calculated based on the slip angle of the vehicle and the like. Then, a target yaw moment Myst and a target deceleration Gbst are calculated using maps, which are not shown and set in advance for the standard state of the vehicle, based on the spin state amount SS and a turn direction of the vehicle.

In Step 350, the target yaw moment Myst is corrected to Iz/Izv times the value thereof in accordance with Expression (12).

Myst←Myst(Iz/Izv) (12)

In Step 360, based on the target yaw moment Myst after the correction and the target deceleration Gbst, target braking forces Fbti (i=fr, fl, rr, and rl) for the respective wheels for mitigating the spin state of the vehicle are calculated.

In Step 370, a drift out state amount DS representing a degree of a drift out state (understeer state) of the vehicle is calculated based on the yaw rate deviation Δγ and the like. Then, a target yaw moment Mydt and a target deceleration Gbdt are calculated using maps, which are not shown and set in advance for the standard state of the vehicle, based on the drift out state amount DS and the turn direction of the vehicle.

In Step 380, the target yaw moment Mydt is corrected to Iz/Izv times the value thereof in accordance with Expression (13).

Mydt←Mydt(Iz/Izv) (13)

In Step 390, based on the target yaw moment Mydt after the correction and the target deceleration Gbdt, the target braking forces Fbti (i=fr, fl, rr, and rl) for the respective wheels for mitigating the drift out state of the vehicle are calculated.

In Step 400, a slip ratio of the each wheel is controlled by control of the braking pressure for the each wheel so that a braking force Fbi of the each wheel reaches the corresponding target braking force Fbti, and as a result, the spin state or the drift out state of the vehicle is mitigated. It should be noted that the braking force of the each wheel may be attained by calculating a target braking pressure of the each wheel based on the target braking force Fbti, and controlling a braking pressure of the each wheel to reach the corresponding target braking pressure.

As understood from the above description, according to the first embodiment, in Step 20, the overall weight W of the vehicle is calculated, in Step 30, the stability factor Kh of the vehicle is calculated, and in Step 60, the movable load Wlo of the vehicle is calculated. Moreover, in Step 80, the distance Lf in the vehicle longitudinal direction between the center of gravity 100 of the vehicle and the axle 102F of the front wheel is calculated, and in Step 90, the axle load Wf of the front wheel and the axle load Wr of the rear wheel are calculated. Then, in Step 100, the cornering powers Kf and Kr of the tires of the front wheel and the rear wheel are calculated based on the respective axle loads Wf and Wr.

Moreover, in Step 110, the yaw moment of inertia Iz of the vehicle is calculated based on the movable load Wlo of the vehicle and the like, and in Step 120, the steering response time constant coefficient Tp is calculated based on the cornering powers Kf and Kr and the yaw moment of inertia Iz. Then, in Step 130, the steering response time constant coefficient Tp is used to calculate the reference yaw rate yst of the vehicle.

Thus, even when the overall weight of the vehicle and the vehicle longitudinal direction position of the vehicle center of gravity change, the yaw moment of inertia Iz of the vehicle changed by those changes can be estimated. Thus, even when the yaw moment of inertia of the vehicle is changed by the change in load state of the vehicle, the reference yaw rate yst as the reference motion state amount of the vehicle can highly precisely be calculated by using the steering response time constant coefficient Tp reflecting the change.

Particularly, according to the first embodiment, on the assumption that the center of gravity of the vehicle is at the center of gravity when the movable load exists, the yaw moment of inertia Izv of the vehicle in the standard state and the yaw moment of inertia Izlo of the movable load are calculated, and the sum thereof is calculated as the yaw moment of inertia Iz. Then, when the yaw moment of inertia Izlo of the movable load is calculated, the guard processing is applied to the distance Lflo in the vehicle longitudinal direction between the center of gravity of the movable load and the axle of the front wheels so as not to exceed the range between the minimum threshold Lfmin and the maximum threshold Lfmax.

Thus, according to the first embodiment, even when the overall weight of the vehicle and the vehicle longitudinal direction position of the vehicle center of gravity change, the yaw moment of inertia Iz of the vehicle reflecting the changes can reliably be estimated, thereby preventing Iz from being calculated to be an abnormal value.

Moreover, in Step 320, it is determined whether or not the turn behavior of the vehicle is degraded, that is, whether or not the stabilization of the turn motion of the vehicle is necessary, by determining whether or not the absolute value of the deviation Δγ between the actual yaw rate γ of the vehicle and the reference yaw rate yst exceeds the reference value γco. Then, when such a determination that the turn behavior of the vehicle is degraded is made, in Step 330, whether or not the vehicle is in the spin state is determined. When such a determination that the vehicle is in the spin state is made, in Steps 340 to 360 and Step 400, the control of the braking force for mitigating the spin state of the vehicle is carried out. In contrast, when such a determination that the vehicle is in the drift out state is made, in Steps 370 to 390 and Step 400, the control of the braking forces for mitigating the drift out state of the vehicle is carried out.

Thus, according to the first embodiment, even when the overall weight of the vehicle and the vehicle longitudinal direction position of the vehicle center of gravity change, the reference yaw rate yst of the vehicle reflecting those changes can be calculated, and as a result, the turn motion of the vehicle can be appropriately stabilized. It should be noted that those working effects are similarly provided in a second embodiment described later.

### Second Embodiment

FIG. 7 is a flowchart for illustrating a routine of calculating the reference yaw rate in accordance with the method of calculating the reference motion state according to a second embodiment of the present invention.

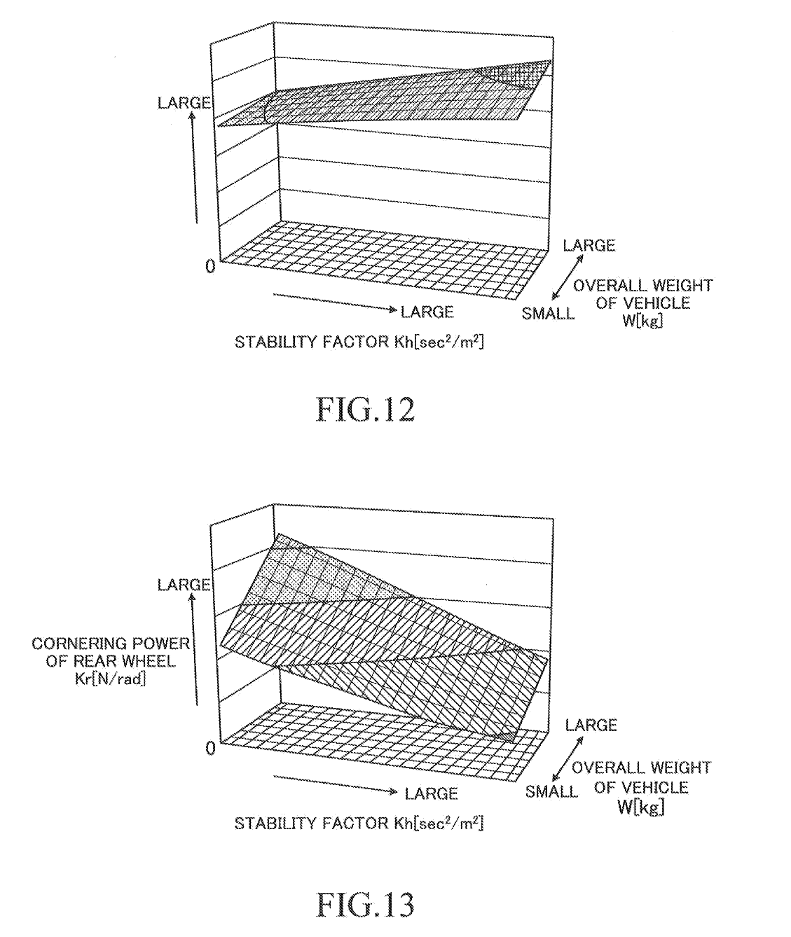

In the second embodiment, the ROM of the electronic control device 30 stores the flowchart illustrated in FIG. 7, and various values of the standard state of the vehicle described later, and stores maps illustrated in FIG. 12 to FIG. 14. Moreover, the electronic control device 30 calculates the reference yaw rate yst of the vehicle in accordance with the flowchart illustrated in FIG. 7. Further, the electronic control device 30, as in the first embodiment, carries out the motion control of the vehicle in accordance with the flowchart illustrated in FIG. 4. Thus, a description of the motion control of the vehicle in this embodiment is omitted.

As illustrated in FIG. 7, Steps 210 to 250 are carried out in the same way as Steps 10 to 50 of the first embodiment, respectively. As a result, the overall weight W of the vehicle and the stability factor Kh of the vehicle are estimated, and whether or not the calculation of the steering response time constant coefficient Tp is unnecessary is determined.

It should be noted that, when the negative determination is made in Step 240, the control proceeds to Step 260, and when the affirmative determination is made, the control proceeds to Step 250. Then, in Step 250, as in the case of Step 50, the steering response time constant coefficient Tp is set to the standard value Tpv set in advance for the standard state of the vehicle without calculating the yaw moment of inertia Iz of the vehicle and the like, and then, the control proceeds to Step 290.

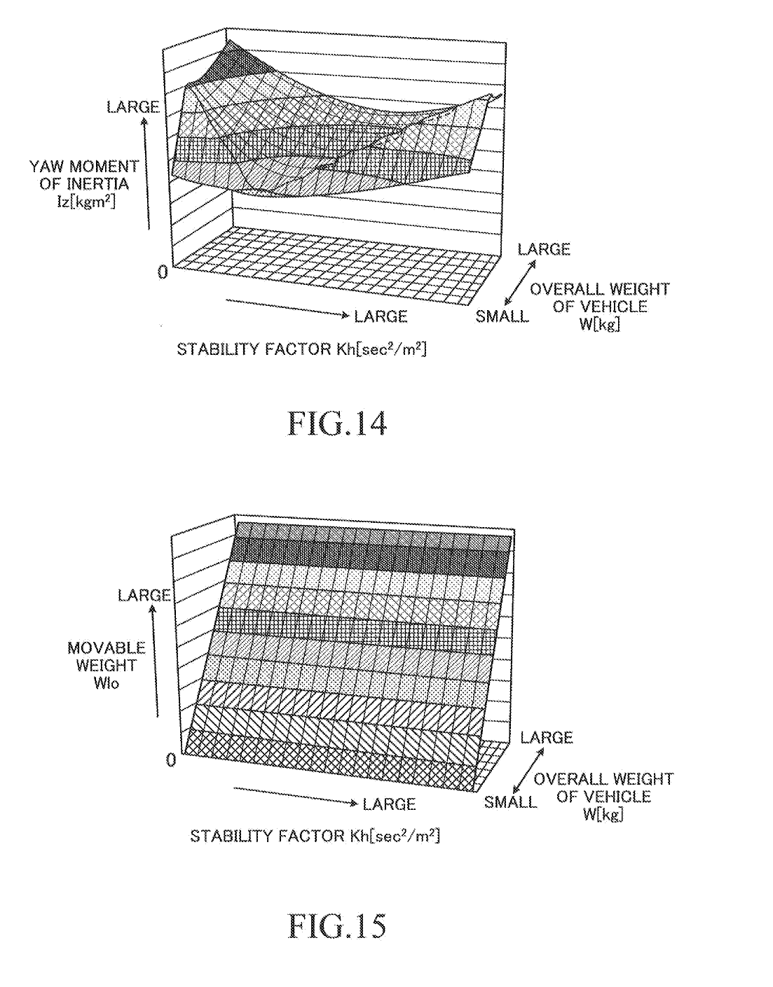

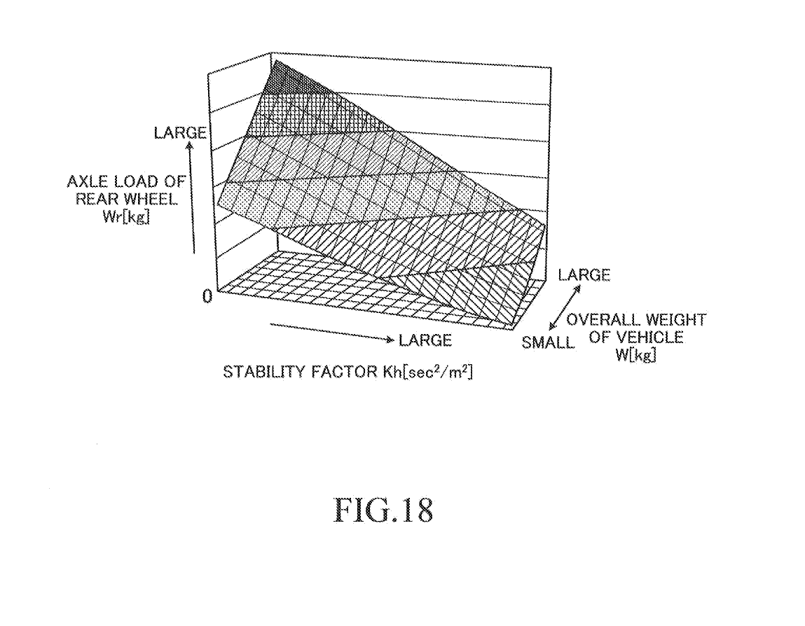

In Step 260, the cornering powers Kf and Kr of the tires of the front wheel and the rear wheel are respectively calculated using the maps illustrated in FIG. 12 and FIG. 13 based on the overall weight W of the vehicle and the stability factor Kh of the vehicle. It should be noted that gridlines drawn on planes of the maps illustrated in FIG. 12 and FIG. 13 represent scales of the overall weight W of the vehicle and the stability factor Kh. This holds true for the maps of FIG. 14 and FIG. 18 described later.

In Step 270, the yaw moment of inertia Iz [kgm²] of the vehicle is calculated using the map illustrated in FIG. 14 based on the overall weight W of the vehicle and the stability factor Kh of the vehicle.

In Step 280, in the same way as in Step 110 of the first embodiment, based on the cornering powers Kf and Kr of the tires of the front wheel and the rear wheel, and the yaw moment of inertia Iz of the vehicle, the steering response time constant coefficient Tp is calculated in accordance with Expression (2).

In Step 290, in the same way as in Step 130 of the first embodiment, the reference yaw rate yst of the vehicle is calculated by using the steering response time constant coefficient Tp calculated in Step 250 or 280 based on the actual steering angle δ of the front wheel, the lateral acceleration Gy of the vehicle, and the vehicle speed V.

In this way, according to the second embodiment, in Step 260, the cornering powers Kf and Kr of the tires of the front wheel and the rear wheel are respectively calculated using the maps illustrated in FIG. 12 and FIG. 13 based on the overall weight W of the vehicle and the stability factor Kh of the vehicle. Moreover, in Step 270, the yaw moment of inertia Iz of the vehicle is calculated using the map illustrated in FIG. 14 based on the overall weight W of the vehicle and the stability factor Kh of the vehicle. Then, in Step 280, based on the cornering powers Kf and Kr of the front wheel and the rear wheel, and the yaw moment of inertia Iz of the vehicle, the steering response time constant coefficient Tp is calculated.

Thus, according to the second embodiment, similarly to the case of the first embodiment, even when the overall weight of the vehicle and the vehicle longitudinal direction position of the vehicle center of gravity change, the yaw moment of inertia Iz of the vehicle changed by those changes can be estimated. The yaw moment of inertia Iz of the vehicle can be estimated more efficiently and easily than in the case of the first embodiment, and a calculation load on the electronic control device 30 can be reduced.

It should be noted that, according to the first and second embodiments, in Steps 90, 100, and 260, the cornering powers Kf and Kr of the tires of the front wheel and the rear wheel are calculated as the values based on the overall weight W of the vehicle and the stability factor Kh of the vehicle. Then, in Steps 120 and 280, the steering response time constant coefficient Tp is calculated based on the cornering powers Kf and Kr and the yaw moment of inertia Iz of the vehicle.

Thus, compared with the case in which the steering response time constant coefficient Tp is calculated by using the estimated yaw moment of inertia Iz and the cornering powers of the front wheel and the rear wheel set in advance, even in a case in which the overall weight of the vehicle and the like change, the steering response time constant coefficient Tp can be correctly calculated. Thus, independently of the changes in the overall weight of the vehicle, and the vehicle longitudinal direction position of the vehicle center of gravity, the reference yaw rate of the vehicle can more precisely be calculated.

Moreover, according to the first and second embodiments, in Steps 40 and 240, whether or not the calculation of the steering response time constant coefficient Tp is unnecessary is determined based on the overall weight W of the vehicle and the stability factor Kh of the vehicle. Then, when the affirmative determination is made, the steering response time constant coefficient Tp is not calculated, and in Steps 50 and 250, the steering response time constant coefficient Tp is set to the standard value Tpv set in advance for the standard state of the vehicle.

Therefore, in the state in which the change amounts of the overall weight W and the stability factor Kh are small with respect to the values in the standard state of the vehicle, and the change in steering response time constant coefficient is also small, unnecessary calculation of acquiring the steering response time constant coefficient can be avoided. Thus, the calculation load on the electronic control device 30 can be reduced.

### First Modified Example

FIG. 8 is a flowchart for illustrating a principal part of the routine of calculating the reference yaw rate according to a first modified example of the present invention corresponding to the first embodiment.

In this first modified example, the electronic control device 30 includes a nonvolatile storage device, which is not shown, and, each time the steering response time constant coefficient Tp is calculated, the electronic control device 30 overwrites and stores the overall weight W of the vehicle, the stability factor Kh of the vehicle, and the steering response time constant coefficient Tp in the storage device. This holds true for a second modified example described later.

As illustrated in FIG. 8, in the routine of calculating the reference yaw rate of this modified example, when the negative determination is made in Step 40, the control does not proceed to Step 60, but proceeds to Step 45. It should be noted that Steps other than Steps 45 and 55 are executed in the same manner as in the case of the first embodiment.

In Step 45, a difference W-Wf between the overall weight W of the vehicle calculated in Step 20 and the overall weight Wf of the vehicle stored in the storage device is calculated as a change amount ΔW of the overall weight of the vehicle. Moreover, a difference Kh−Khf between the stability factor Kh of the vehicle calculated in Step 30 and the stability factor Khf of the vehicle stored in the storage device is calculated as a change amount ΔKh of the stability factor of the vehicle.

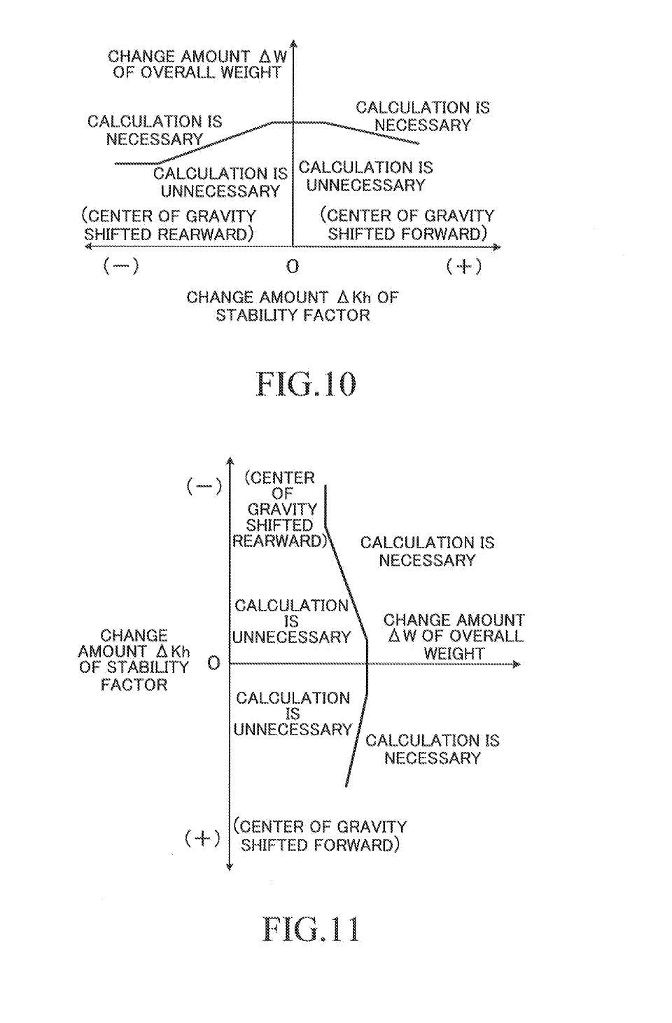

Then, whether or not the calculation of the steering response time constant coefficient Tp is unnecessary is determined using a map illustrated in FIG. 10 based on the change amount ΔW of the overall weight W and the change amount ΔKh of the stability factor. Then, when the negative determination is made, the control proceeds to Step 60, and when the affirmative determination is made, in Step 55, the steering response time constant coefficient Tp is set to a steering response time constant coefficient Tpf stored in the storage device, and then, the control proceeds to Step 130.

### Second Modified Example

FIG. 9 is a flowchart for illustrating a principal part of the routine of calculating the reference yaw rate according to a second modified example of the present invention corresponding to the second embodiment.

As illustrated in FIG. 9, in the routine of calculating the reference yaw rate of this modified example, when the negative determination is made in Step 240, the control does not proceed to Step 260, but proceeds to Step 245. It should be noted that Steps other than Steps 245 and 255 are executed in the same manner as in the case of the second embodiment.

In Step 245, the difference W-Wf between the overall weight W of the vehicle calculated in Step 220 and the overall weight Wf of the vehicle stored in the storage device is calculated as the change amount ΔW of the overall weight of the vehicle. Moreover, the difference Kh-Khf between the stability factor Kh of the vehicle calculated in Step 230 and the stability factor Khf of the vehicle stored in the storage device is calculated as the change amount ΔKh of the stability factor of the vehicle.

Then, whether or not the calculation of the steering response time constant coefficient Tp is unnecessary is determined using the map illustrated in FIG. 10 based on the change amount ΔW of the overall weight W and the change amount ΔKh of the stability factor. Then, when the negative determination is made, the control proceeds to Step 260, and when the affirmative determination is made, in Step 255, the steering response time constant coefficient Tp is set to the steering response time constant coefficient Tpf stored in the storage device, and then, the control proceeds to Step 290.

Moreover, according to the first and second embodiments, in Steps 45 and 245, whether or not the calculation of the steering response time constant coefficient Tp is unnecessary is determined based on the change amount ΔW of the overall weight of the vehicle and the change amount ΔKh of the stability factor of the vehicle. Then, when the affirmative determination is made, the steering response time constant coefficient Tp is not calculated, and in Steps 55 and 255, the steering response time constant coefficient Tp is set to the steering response time constant coefficient Tpf stored in the storage device.

Thus, in the state in which the change amounts of the overall weight W and the stability factor Kh are small with respect to the values when the previous steering response time constant coefficient Tp is calculated, and the change in steering response time constant coefficient is also small, the unnecessary calculation of acquiring the steering response time constant coefficient can be avoided. Thus, the calculation load imposed on the electronic control device 30 can further be reduced compared with the first and second embodiments.

It should be noted that, in the above-mentioned Steps 45 and 245, as illustrated in FIG. 10, whether or not the change amount ΔW of the overall weight of the vehicle is equal to or less than a threshold determined by the change amount ΔKh of the stability factor of the vehicle is determined. However, as illustrated in FIG. 11, whether or not the change amount ΔKh of the stability factor of the vehicle is equal to or less than a threshold determined by the change amount ΔW of the overall weight of the vehicle may be determined.

The specific embodiment of the present invention is described in detail above. However, the present invention is not limited to the above-mentioned embodiment. It is apparent for those skilled in the art that various other embodiments may be employed within the scope of the present invention.

For example, in the respective embodiments and modified examples, the reference motion state amount of the vehicle is the reference yaw rate yst, but may be a reference lateral acceleration of the vehicle.

Moreover, in the respective embodiments and modified examples, the deviation Δγ between the actual yaw rate γ of the vehicle and the reference yaw rate yst is calculated, and whether or not the turn behavior of the vehicle is degraded is determined by determining whether or not the absolute value of the yaw rate deviation Δγ exceeds the reference value γco. However, the reference yaw rate yst may be used for arbitrary control of the vehicle such as antiskid control.

Moreover, in the respective embodiments and modified examples, both the actual yaw rate γ of the vehicle and the lateral acceleration Gy of the vehicle used for the calculation of the reference yaw rate yst are the detected values. However, a two-wheel model of the vehicle in which the overall weight W of the vehicle and the stability factor Kh of the vehicle are variable parameters may be used to calculate the yaw rate γ of the vehicle and the lateral acceleration Gy of the vehicle based on the vehicle speed and the steering angle of the front wheel.

Moreover, in the respective embodiments and modified examples, whether or not the absolute value of the deviation Δγ between the actual yaw rate γ of the vehicle and the reference yaw rate yst exceeds the reference value γco is determined. However, a steering angle conversion value Δγs of the magnitude of the deviation Δγ of the yaw rate, namely, a value of the steering angle converted from the absolute value of the deviation Δγ may be calculated, and whether or not a steering angle equivalent value Δγs exceeds a reference value may be determined. In this case, the steering angle conversion value Δγs may be calculated by multiplying the magnitude of the deviation Δγ of the yaw rate by NL/V where N is a steering gear ratio.

Moreover, in the above-mentioned first and second embodiments, in Steps 40 and 240, whether or not the calculation of the reference yaw rate yst of the vehicle is unnecessary is determined based on the overall weight W of the vehicle and the stability factor Kh of the vehicle. However, this determination may be omitted.

Moreover, in the determination of whether or not the calculation of the reference yaw rate yst of the vehicle is unnecessary, the overall weight W of the vehicle may be replaced by the change amount (movable load) of the overall weight W of the vehicle with respect to the overall weight W of the vehicle in the standard state of the vehicle. Moreover, in the determination of whether or not the calculation of the reference yaw rate yst of the vehicle is unnecessary, the stability factor Kh of the vehicle may be replaced by the change amount of the position in the vehicle longitudinal direction of the vehicle center of gravity with respect to the vehicle center of gravity in the standard state of the vehicle.

Moreover, in the above-mentioned respective embodiments and modified examples, the routine of calculating the reference yaw rate yst is independent of the routine of controlling travel motion of the vehicle. However, the routine of calculating the reference yaw rate yst may be modified so as to be executed as a part of the routine of controlling travel motion of the vehicle.

Moreover, in the above-mentioned first embodiment, the movable load Wlo of the vehicle, which is the change amount of the weight of the vehicle with respect to the standard weight Wv, is calculated in accordance with Expression (3), but may be calculated using a map illustrated in FIG. 15 based on the overall weight W of the vehicle and the stability factor Kh.

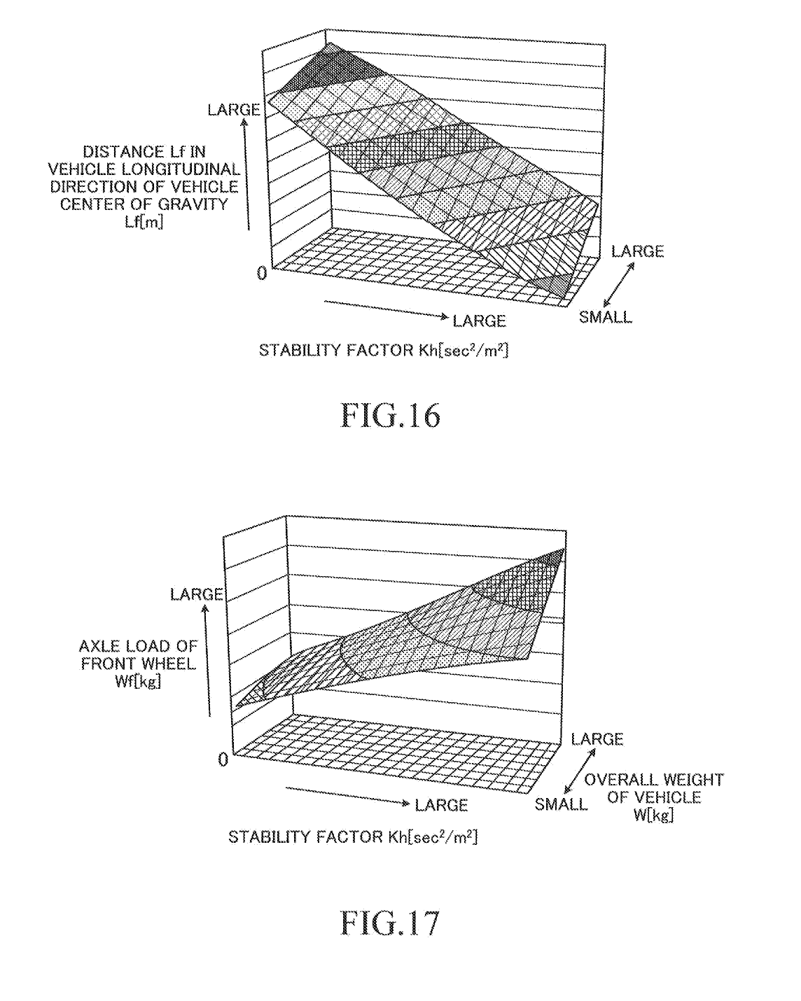

Moreover, the distance Lf in the vehicle longitudinal direction between the center of gravity of the vehicle and the axle of the front wheel may be calculated using a map illustrated in FIG. 16 based on the overall weight W of the vehicle and the stability factor Kh.

Moreover, in the above-mentioned first embodiment, the axle load Wf of the front wheels and the axle load Wr of the rear wheels are calculated based on the overall weight W of the vehicle and the distances Lr and Lf between the center of gravity of the vehicle and the axles respectively in accordance with Expressions (6) and (7). However, a modification may be made where the axle load Wf of the front wheels and the axle load Wr of the rear wheels are calculated using maps illustrated in FIG. 17 and FIG. 18 based on the overall weight W of the vehicle and the stability factor Kh of the vehicle.

Moreover, in the above-mentioned first embodiment, the cornering powers Kf and Kr of the tires of the front wheels and the rear wheels are calculated based on the axle load Wf of the front wheels and the axle load Wr of the rear wheels. However, a modification may be made where the cornering powers Kf and Kr of the tires of the front wheels and the rear wheels are calculated using the maps illustrated in FIG. 12 and FIG. 13 based on the overall weight W of the vehicle and the stability factor Kh of the vehicle.

Moreover, in the above-mentioned respective embodiments and modified examples, the vehicle is a minivan, but the vehicle to which the method of calculating the reference motion state amount according to the present invention may be an arbitrary vehicle such as a bus or a truck having a large variation of the movable load and a large variation of the center of gravity of the vehicle.

Moreover, in the above-mentioned respective embodiments and modified examples, the stabilization of the travel motion of the vehicle is achieved by controlling the braking force on the each wheel. However, the stabilization of the travel motion of the vehicle may be achieved by controlling the steering angle of the wheel or may be achieved by controlling both the braking force of the each wheel and the steering angle of the each wheel.

1.-7. (canceled)

8. A method of calculating a reference motion state amount of a vehicle in a relationship of a first-order lag with respect to a normative motion state amount of the vehicle, the method comprising:
estimating an overall weight of the vehicle and a stability factor of the vehicle;
estimating a change amount of the overall weight of the vehicle and a change amount of the vehicle longitudinal direction position of the vehicle center of gravity with respect to a standard state of the vehicle based on the estimated overall weight and stability factor;
estimating a change amount of the yaw moment of inertia of the vehicle based on the change amount of the overall weight of the vehicle and the change amount of the vehicle longitudinal direction position of the vehicle center of gravity;
calculating a sum of the estimated change amount of the yaw moment of inertia and a standard value of the yaw moment of inertia set in advance for the standard state of the vehicle as the estimated value of the yaw moment of inertia of the vehicle;
calculating a time constant of the first-order lag by using the estimated value of the yaw moment of inertia; and
calculating the reference motion state amount of the vehicle by using the calculated time constant.

9. A method of calculating a reference motion state amount of a vehicle according to claim 8, wherein the time constant of the first-order lag is a product of a vehicle speed and a coefficient, and the coefficient is calculated by using the estimated value of the yaw moment of inertia.

10. A method of calculating a reference motion state amount of a vehicle according to claim 9, further comprising calculating estimated values of cornering powers of a front wheel and a real wheel based on the overall weight of the vehicle and a vehicle longitudinal direction position of a center of gravity of the vehicle, wherein the coefficient is calculated by using the estimated value of the yaw moment of inertia and the estimated values of the cornering powers of the front wheel and the rear wheel.

11. A method of calculating a reference motion state amount of a vehicle according to claim 8, further comprising:
calculating the estimated value of the yaw moment of inertia of the vehicle and estimated values of cornering powers of a front wheel and a rear wheel by using a storage device for storing a relationship acquired in advance between the overall weight of the vehicle and the stability factor of the vehicle, and the yaw moment of inertia of the vehicle, and storing a relationship acquired in advance between the overall weight of the vehicle and the stability factor of the vehicle, and the cornering powers of the front wheel and the rear wheel; and
calculating the time constant of the first-order lag by using the estimated value of the yaw moment of inertia and the estimated values of the cornering powers of the front wheel and the rear wheel.

12. A method of calculating a reference motion state amount of a vehicle according to claim 11, wherein the time constant of the first-order lag is a product of a vehicle speed and a coefficient, and the coefficient is calculated by using the estimated value of the yaw moment of inertia and the estimated values of the cornering powers of the front wheel and the rear wheel.

13. A method of calculating a reference motion state amount of a vehicle according to claim 8, further comprising setting, when one of the overall weight of the vehicle and the stability factor of the vehicle is equal to or less than a threshold value determined by another one thereof, the estimated value of the yaw moment of inertia to the standard value without calculating the estimated value of the yaw moment of inertia of the vehicle.

14. A method of calculating a reference motion state amount of a vehicle according to claim 9, further comprising setting, when one of the overall weight of the vehicle and the stability factor of the vehicle is equal to or less than a threshold value determined by another one thereof, the estimated value of the yaw moment of inertia to the standard value without calculating the estimated value of the yaw moment of inertia of the vehicle.

15. A method of calculating a reference motion state amount of a vehicle according to claim 10, further comprising setting, when one of the overall weight of the vehicle and the stability factor of the vehicle is equal to or less than a threshold value determined by another one thereof, the estimated value of the yaw moment of inertia to the standard value without calculating the estimated value of the yaw moment of inertia of the vehicle.

16. A method of calculating a reference motion state amount of a vehicle according to claim 11, further comprising setting, when one of the overall weight of the vehicle and the stability factor of the vehicle is equal to or less than a threshold value determined by another one thereof, the estimated value of the yaw moment of inertia to the standard value without calculating the estimated value of the yaw moment of inertia of the vehicle.

17. A method of calculating a reference motion state amount of a vehicle according to claim 12, further comprising setting, when one of the overall weight of the vehicle and the stability factor of the vehicle is equal to or less than a threshold value determined by another one thereof, the estimated value of the yaw moment of inertia to the standard value without calculating the estimated value of the yaw moment of inertia of the vehicle.
